(19) United States
(12) Patent Application Publication
(10) Pub. No.: US 2008/0296521 A1
(43) Pub. Date: Dec. 4, 2008

(54) METHOD AND SYSTEM FOR REDUCING OR ELIMINATING UNCONTROLLED MOTION IN A MOTION CONTROL SYSTEM

(75) Inventors: Rajagopal Narayanasamy, Bangalore (IN); Sankar Murmu, Bangalore (IN)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/755,467

(22) Filed: May 30, 2007

(51) Int. Cl. G01D 5/347; G01N 21/88

(52) U.S. Cl. 250/559.45

(57) ABSTRACT

A method and system for reducing or eliminating uncontrolled motion in a motion control system is disclosed herein. The method includes defining at least one closed motion control loop. The motion control loop comprises a plurality of feedback control loops. The method further includes detecting a faulty feedback control loop from among the plurality of feedback control loops based on a faulty feedback signal. Once the faulty feedback signal is detected, the faulty feedback signal in the faulty feedback control loop is swapped to an operative feedback signal while the motion control loop is active. In an embodiment the motion control loop includes a velocity feedback control loop and a position feedback control loop.

### FIELD OF THE INVENTION

This invention relates generally to motion control systems and methods, and more particularly relates to a system and method for reducing or eliminating uncontrolled motion in a motion control system.

### BACKGROUND OF THE INVENTION

The usage of feedback control loops in controlling motion of a device is very common. However there may occur errors in the control loop, which may result in uncontrolled motion of the device. Generally an encoder or sensor along with a controller is used in a feedback loop to control the operation of a motor, which in turn drives a device directly or via one or more gears or other transmission. Due to events like encoder or sensor failure or the cable that carries the signal from the encoder or sensor being disconnected, the signals from the encoder or sensor are not properly carried to the controller and hence the loop is not closed and may result in random or abrupt movement of the device. It is typically desirable to reduce or eliminate such uncontrolled device motion.

Generally, a positioner in a medical imaging system is used for positioning of a patient with respect to a medical imaging device, either by moving the patient or the medical imaging device. Examples of medical imaging devices may include X-ray devices and vascular imaging devices. One example of a positioner is a vascular gantry comprising a C-arm and a pivot axis. The positioner includes mechanisms for lift and pivot in a vascular gantry and longitudinal and lateral tilt in a patient table. In certain positioners, velocity and position encoders are provided along with a controller that uses velocity and position feedback control loops to control the motion of the positioner.

Considering an example of a vascular tilt table, during an axis movement, if the velocity encoder signal is lost due to encoder cable fault or encoder malfunction then the velocity control loop will become unstable and create an uncontrolled motion on the axis. This will interrupt an on going medical procedure. It will also be difficult to unload the patient, because after the encoder fault, the axis will not be usable until the encoder issue is resolved.

Some of the solutions in the industry suggest detecting encoder signal loss using over speed detection logic and then applying brakes for the axis. However, the over speed detection and brake application will take a relatively long time, partly due to the time required to actuate the brake, which is typically electromagnetic. In addition, on actuation of the brake, the equipment will not be capable of use until the problem is fixed.

Some of the solutions suggest detecting a feedback failure and changing over from a closed control loop to an open control loop. However usage of open control loop is often not desirable due to the decrease in control accuracy.

Thus there exists a need to provide a method to reduce or eliminate uncontrolled motion in a device which uses feedback loop, especially when the uncontrolled motion is caused due to the failure of an encoder/sensor used in the feedback loop.

### SUMMARY OF THE INVENTION

The above-mentioned shortcomings, disadvantages and problems are addressed herein which will be understood by reading and understanding the following specification.

The present invention provides a method of reducing or eliminating uncontrolled motion in a motion control system. The method includes the step of: defining at least one closed motion control loop, the motion control loop being configured to include a plurality of feedback control loops. The method further includes the step of detecting a faulty feedback control loop from among the plurality of feedback control loops based on a faulty feedback signal. The method further includes the step of swapping of the faulty feedback signal in the faulty feedback control loop with an operative feedback signal while the motion control loop is active. In an embodiment, the motion control loop includes a position feedback control loop and a velocity feedback control loop. Upon failure of position or velocity control loop, the faulty encoder is swapped with an operative encoder so that the motion control loop is complete.

In another embodiment, a motion control mechanism is disclosed. The mechanism includes: a faulty encoder detector; and a feedback control mechanism for swapping a faulty encoder detected by the faulty encoder detector with an operative encoder in an active closed motion control loop. In an embodiment, the feedback control mechanism is configured to select an operative feedback sensor in the event of detection of a faulty feedback sensor in active motion control loop. Once the operative feedback sensor is selected the faulty feedback sensor is swapped with the operative feedback sensor.

In yet another embodiment, a motion control system is disclosed. The system includes: a motion control loop defined by a plurality of feedback control loops; a motion control mechanism operatively coupled to motion control loop; and a motor drive coupled to motion control mechanism; wherein the motion control mechanism is configured to eliminate uncontrolled motion caused due failure of a feedback control loop in the motion control system.

Various other features, objects, and advantages of the invention will be made apparent to those skilled in the art from the accompanying drawings and detailed description thereof.

### BRIEF DESCRIPTION OF THE DRAWINGS

A clear conception of the advantages and features constituting inventive arrangements, and of various construction and operational aspects of typical mechanisms provided by such arrangements, are readily apparent by referring to the following illustrative, exemplary, representative, and non-limiting figures, which form an integral part of this specification, in which like numerals generally designate the same elements in the several views, and in which:

FIG. 1 is a high level flowchart illustrating a method of eliminating uncontrolled motion in a motion control system;

FIG. 2 is flowchart illustrating the steps of a method of eliminating uncontrolled motion as described in FIG. 1;

FIG. 3 is block diagram of a motion control mechanism as described in an embodiment of the invention;

FIG. 4 is block diagram of a motion control system as described in an embodiment of the invention; and

FIGS. 5A and 5B illustrate a block diagram illustrating the swapping technique used in an embodiment of the invention.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

In various embodiments, a method and system for reducing or eliminating uncontrolled motion in a motion control system is disclosed. The system allows swapping of a faulty feedback signal in a feedback control loop with an operative feedback control signal, based on the faulty feedback loop signal. in the event of an encoder failure or encoder malfunction. The swapping is done while the motion control system is active or operative.

In an embodiment the invention facilitates enabling a degraded mode of operation wherein even after detecting failure of a feedback control loop the device is allowed to complete at least one motion control cycle so that the ongoing operation of the device is not interrupted for at least one cycle.

In another embodiment, a motion control mechanism is disclosed. The motion control mechanism disclosed can be used in various closed motion control loops. A motion control system may be configured to have plurality of motion control loops. The motion control loop may include plurality of feedback control loops for controlling the motion of the device. The feedback control loop may be defined through an encoder and a controller. The motion control mechanism described is applicable to any motion control loops, wherein there are two or more feedback control loops, so that if an encoder or feedback sensor in the encoder of one feedback control loop fails, the motion control loop can be completed through an operative encoder or an operative feedback sensor in another feedback control loop.

In another embodiment, the invention provides a motion control system for a positioner. The motion control system is operated through a motion control loop. The motion control loop includes a position feedback control loop and velocity feedback control loop. The position control loop and the velocity control loop use a position feedback signal and a velocity feedback signal respectively. In the event of a faulty position feedback signal or velocity feedback signal, the motion control loop is completed through an operative velocity feedback signal or operative position feedback signal.

While the present technique is described herein with reference to medical imaging applications and, it should be noted that the invention is not limited to this or any particular application or environment. Rather, the technique may be employed in a range of applications where motion of a device is being controlled by a closed motion control loop comprising at least two feedback control loops.

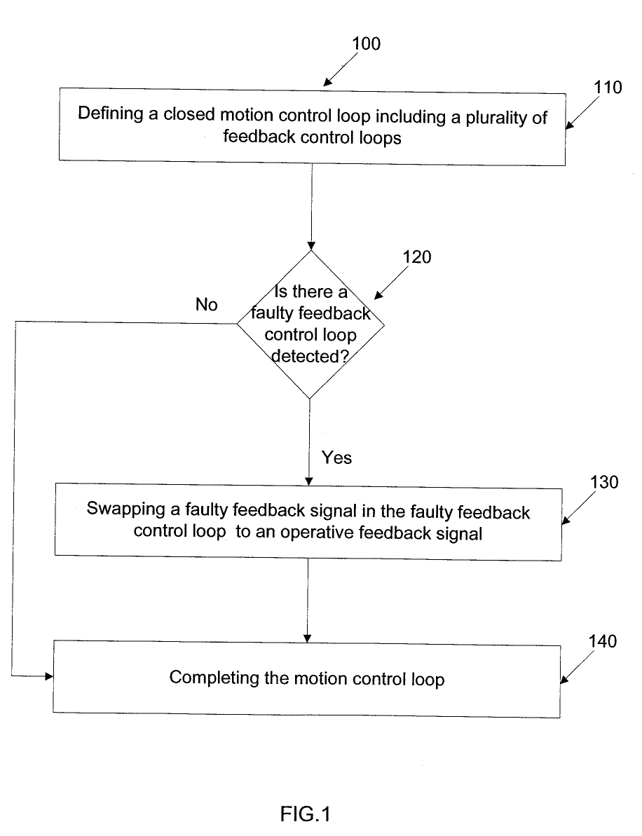

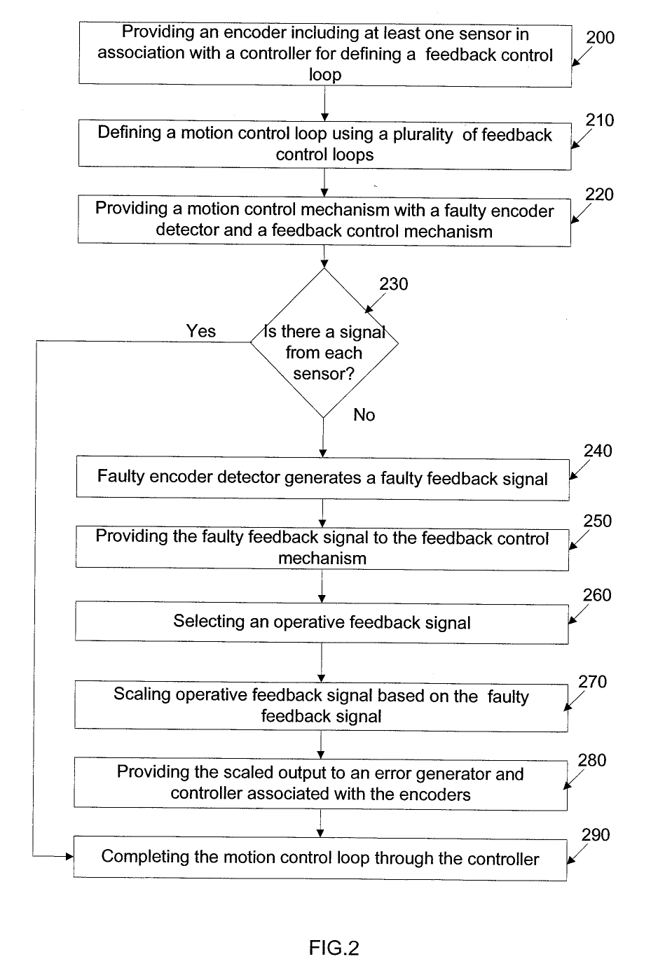

FIG. 1 is a high level flowchart illustrating a method of reducing or eliminating uncontrolled motion in a motion control system. In method 100, at step 110, at least one motion control loop is defined. The motion control loop includes a plurality of feedback control loops. The motion control loop is a closed loop, by which the motion of a device is being controlled. There can be plurality of motion control loops in a motion control system to control the motion of a device in different axis. The feedback loops generally include an encoder connected to a controller. The encoder includes at least one feedback sensor along with its interface circuitry. At step 120, a faulty feedback control loop is detected from among the feedback control loops. The detection is done based on a faulty feedback signal. The faulty feedback signal is identified by continuously checking a signal from the feedback sensor. A faulty feedback signal may occur due to the failure or malfunction of the feedback sensor or the interfacing circuitry in the encoder or due to cable failure or due to any other reasons by which encoder is disconnected from the controller. In an example, the faulty feedback signal can be detected by checking for a signal from the feedback sensor in the encoder continuously and in the event of absence of a signal from the feedback sensor it may be taken as detection of a faulty feedback signal. The faulty feedback signal indicates a faulty feedback control loop. In the absence of a faulty feedback signal, the motion control loop is completed through encoder and the controller as shown in step 140. If a faulty feedback control signal is detected, at step 130, the faulty feedback signal is swapped with an operative feedback signal. At step 140, the motion control loop is completed through the operative feedback signal. Various steps involved in the method will be explained in detail with reference to FIG. 2

FIG. 2 is flowchart illustrating the steps of method of eliminating uncontrolled motion as described in FIG. 1. At step 200, a plurality of feedback control loop is defined. In an example the feedback control loop is defined using an encoder connected to a controller through an error signal generator. The encoder includes a feedback sensor and its interface circuitry. In sophisticated motion control mechanisms, there will be at least two feedback control loops to control the motion of the device. One feedback control loop is provided to control the velocity of the motion and the other to control the position of the device. It includes velocity feedback control loop and a position feedback control loop. A velocity encoder and position encoder along with a controller are provided to define velocity feedback control loop and a position feedback control loop. The velocity and position encoder will have at least one velocity feedback sensor and position feedback sensor respectively. Each encoder is connected to the controller through an error generator. There could be individual controllers corresponding to each encoder or could be a single controller to which each encoder can be connected. The controller can be hardware or software or firmware. In an example PID controllers are used. At step 210, a motion control loop is defined with plurality of feedback control loops. There could be plurality of motion control loops for controlling motions in different axis. The feedback control loops are defined as inner loops, which will define the motion control loop. In an example, the feedback control loops includes position feedback control loop and velocity feedback control loop. At step 220, a motion control mechanism is provided with a faulty encoder detector and a feedback control mechanism. The motion control mechanism is configured to reduce or eliminate the uncontrolled motion of the device. The faulty encoder detector is configured to detect a faulty feedback signal, based on failure or malfunction of the encoder more specifically the failure of a feedback sensor or its interfacing circuitry incorporated in the encoder or to detect a failure in the cable carrying output of the encoder. At step 230, a signal from each feedback sensor is checked by the faulty encoder detector. The detection of the signal indicates that the feedback control loop is operative and hence the control mechanism will proceed with its normal operation as in step 290. At step 240, the faulty encoder detector detects a faulty feedback signal in response to the non-availability of a signal from the feedback sensor. The faulty feedback signal indicates the detection of a faulty feedback control loop, in an example a feedback sensor failure in an encoder. At step 250, the faulty feedback signal is fed to the feedback control mechanism. At step 260, feedback control mechanism is configured to select an operative feedback signal in a feedback control loop. In an example, in the event of feedback sensor failure, an operative feedback sensor in an operative encoder is selected. The selection may be based on the availability of the operative encoder, its location, function, relationship between the faulty encoder and the operative encoder etc. At step 270, the operative feedback signal is or in an example output of the selected feedback sensor is scaled based on the nature of the faulty encoder. At step 280, the scaled output is provided to the controller. Each encoder may have a separate controller or else may have an integrated controller. At step 290, the motion control loop is completed using the operative feedback signal. In an example, the motion control loop is completed through the selected operative feedback sensor avoiding the faulty feedback sensor.

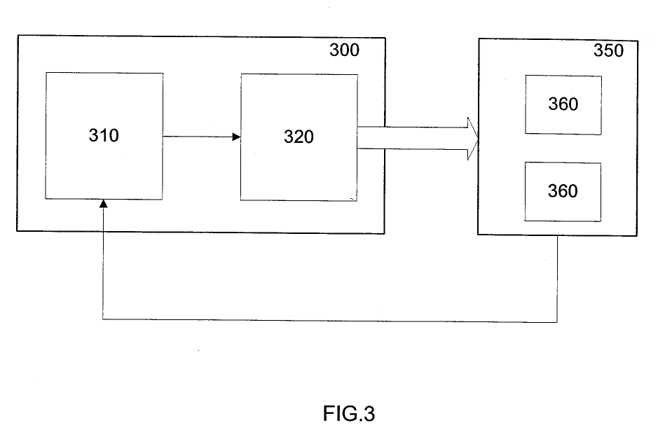

FIG. 3 is block diagram of a motion control mechanism as described in an embodiment of the invention. The motion control mechanism 300 works in association with a motion control loop 350 to reduce or eliminate the uncontrolled motion in a motion control system. The motion control mechanism 300 is configured to include a faulty encoder detector 310 and a feedback control mechanism 320. The motion control loop 350 is formed by plurality of feedback control loops 360.

The motion control mechanism 300 includes the faulty encoder detector 310. The faulty encoder detector 310 may detect the malfunction or failure of the encoder more specifically failure of a feedback sensor and its interface circuitry, in a feedback loop. The faulty encoder detector 310 is configured to check the encoder continuously, at least one time in each motion control cycle. The encoder generally sends a signal to the faulty encoder detector that indicates that the feedback sensor in the encoder is functional or the feedback control loop is operative. The faulty encoder detector 310 can be any detection circuit including hardware, software or firmware detectors that can detect a feedback sensor failure or feedback control loop failure. The faulty encoder detector 310 is configured to generate a faulty feedback signal based on the non-availability of the signal from the feedback sensor. This faulty feedback signal is fed to the feedback control mechanism 320.

The feedback control mechanism 320 is operably coupled to the faulty encoder detector 310 for receiving the faulty feedback signal. The feedback control mechanism 320 is configured to select an operative feedback sensor in a feedback control loop 360 in the event of detection of a faulty feedback control loop 360 and bypass the faulty feedback sensor in the faulty feedback control loop with an operative feedback sensor so that the motion control loop 350 remains closed. The feedback control mechanism 320 in responsive to the input from the faulty encoder detector 310 will select an operative feedback control loop 360. Once an operative feedback sensor/encoder in an operative feedback control loop is selected, the output of the selected feedback sensor/encoder is scaled based on the nature of the faulty feedback sensor. The scaled output is fed to the controller through an error signal generator for completing the motion control loop 350. The scaling step can be optional, based on the usage of the speed reduction mechanism used between the encoders. The scaling factor depends on the speed reduction ratio used between the encoders in the motion control loop.

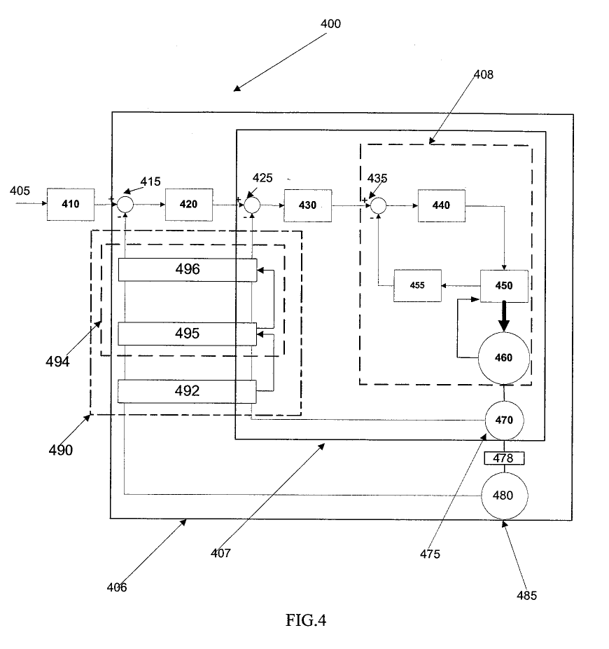

FIG. 4 is block diagram of a motion control system as described in an embodiment of the invention. The motion control system is configured to control the motion of a device. Here the concept is explained in reference to a positioner. However the device need not be limited to positioners. The motion control system is provided with plurality of motion control loops 400. The motion control loops 400 comprise one or more feedback control loops. In the embodiment illustrated, the motion control system comprises three feedback control loops, namely position feedback control loop 406, velocity feedback control loop 407 and torque feedback control loop 408. Generally a user or operator, operating the positioner gives an input to the motion control system 400 in the form of a position command 405. For example, the user may give a command as the input to move the positioner to a distance by pressing a button or using any other interfaces such as joystick, mouse, button etc. The motion control system is provided with a profile generator 410 that will smoothen the user input or position command 405. This could be optional in a motion control system. The output of the profile generator 410 is provided to a position PID (position, integral, derivative) controller 420. More precisely, the output of the profile generator 410 is fed to a position error generator 415 which could be an adder/subtractor circuit, configured to generate a position error signal based on its input. The position error generator 415 is provided with an input from a position encoder 480 which will convey information about the position of the positioner and the other input being the position command 405 provided by the user/profile generator 410. The position encoder 480 includes a position sensor 485 along with its interface circuitry, which provides the position information and the position error generator 415 generates the position error signal based on the inputs, which indicates the correction to be applied in adjusting the position. The position error signal is fed to a position PID controller 420 to control the position of the positioner. The position of the positioner is controlled through the position feedback control loop 406, defined by the position encoder 480, position error generator 415 and position PID controller 420. The output of the position PID controller 420 is provided to a velocity PID controller 430 through a velocity error generator 425, which will generate a velocity error signal corresponding to outputs of a velocity encoder 470 and the position PID controller 420. The output of the velocity PID controller 430 is fed to a torque PID controller 440. The torque PID controller 440 is configured to control the acceleration or torque variation that could be caused due to the load variation. The acceleration or torque is controlled using the torque feedback loop 408. A current sensor 455 is provided to detect the current that is flowing to a motor 460 and is given to the current error generator 435 to generate a torque error signal corresponding to the variations in the current to the motor 460. A power amplifier 450 is provided to amplify the error signal before feeding the same to a motor 460. The velocity encoder 470 is coupled to the motor 460 directly or through some interfaces. Corresponding to the velocity changes of the motor 460, a velocity sensor 475 provided in the velocity encoder 470 generates a signal and is fed to the velocity error generator 415 that generates the velocity error signal which need to be applied as a velocity correction to rotate the motor 460 at a constant speed. The velocity feedback control loop 407 is used to control, the velocity of the positioner, the velocity feedback control loop 407 being defined by the velocity encoder 470, velocity error generator 425 and velocity PID controller 430. The output of the velocity encoder 470 is fed to the position encoder 480 through a speed reduction mechanism 478, generally. The speed reduction mechanism 478 could include a gear assembly or any other similar structures. The output of the position encoder 480 is fed to the position error generator 415. The position error generator 415 generates a position error signal and is used in controlling the position of the positioner. The position feedback control loop 406 is used to control, the position of the positioner, the position feedback control loop 406 being defined by the position encoder 480, position error generator 415 and position PID controller 420.

In an embodiment a motion control mechanism 490 is provided to reduce or eliminate the uncontrolled motion in the motion control system. The motion control mechanism 490 includes faulty encoder detector 492 and a feedback control mechanism 494. The feedback control mechanism 494 includes a selecting unit 495 and a scaling unit 496. The faulty encoder detector 492 is operably coupled to the encoders for detecting the failure of a position encoder 480 or a velocity encoder 470. The faulty encoder detector 492 checks continuously, at least once in each motion cycle, for a signal from the encoders. The faulty encoder detector 492 is configured to generate a faulty feedback signal based on the non-availability of a signal from the position encoder 480 or velocity encoder 470, more specifically from non-availability of signal from the position sensor 485 and velocity sensor 475 in the encoders. This faulty feedback signal indicates the presence of a faulty sensor or a faulty encoder or a faulty feedback control loop. The feedback control mechanism 492 is configured to complete the motion control loop for at least one motion cycle even after detecting a faulty feedback control loop. Based on the faulty feedback signal, the selecting unit 495 will select an operative feedback signal or an operative encoder. The selecting unit 495 is configured for selecting an operative encoder in the event of detection of a faulty feedback control loop or faulty encoder. Once the operative encoder is selected, the output of the operative encoder is scaled using the scaling unit 496, scaling factor being dependent on a speed reduction mechanism 478 used between the encoders. Thus the motion control loop 400 is completed through the selected sensor in the selected encoder.

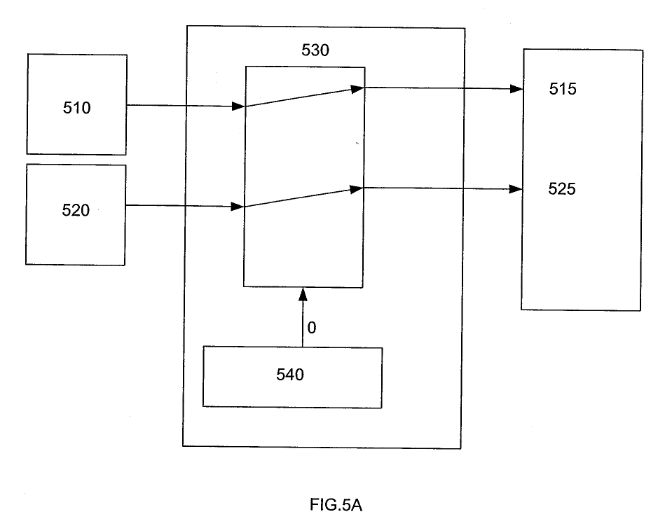

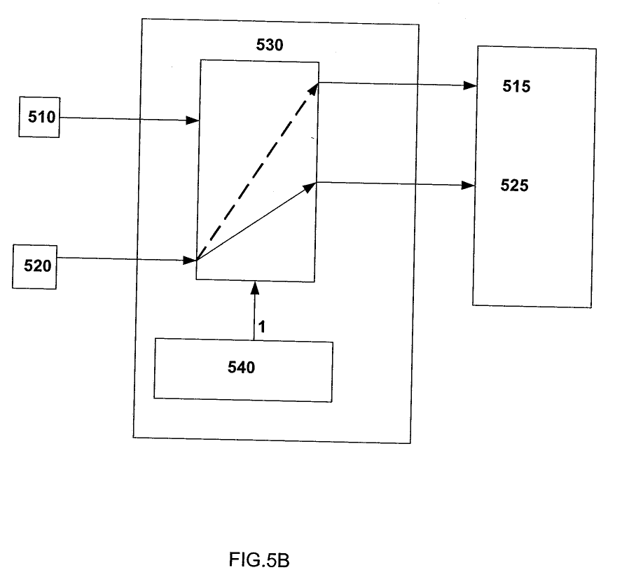

The motion control mechanism 490 is operably coupled to the motion control loop 400 for controlling the motion of the device. The motion control loop 400 controls the operation of the motor drive 460 to stabilize the velocity and position of the device based on the error signals generated using the feedback control loops. The selecting unit is explained in reference to FIGS. 5A and 5B.

FIGS. 5A and 5B show a block diagram illustrating the swapping technique used in an embodiment of the invention. The figures illustrate a velocity encoder 510 and a position encoder 520 and respective velocity decoder 515 and position decoder 525. The velocity decoder 515 and position decoder 525 may be part of the controllers explained above in reference various figures. The encoders 510, 520 are connected to their respective decoders 515, 525 through a selecting unit 530. The velocity encoder 510 includes a velocity sensor and the position encoder 520 includes position sensor along with an interface circuitry. The selecting unit 530 can be controlled by a faulty feedback signal, which could be generated by a faulty encoder detector 540 illustrated in various parts of the specification. In an example the faulty feedback signal is an indication of a velocity sensor failure in the velocity encoder or of a position sensor failure in the position encoder. If the faulty feedback signal to the selecting unit 530 is “0”, the selecting unit 530 will work normally so that the velocity encoder and position encoders are connected to their respective decoders 515 and 525. This is shown in FIG. 5A. The selecting unit 530 can be a multiplier circuit. Considering the example of a velocity encoder failure, the faulty feedback signal is “1’, it indicates that the velocity encoder loss is high and the velocity encoder 510 is a faulty encoder, which includes failure of at least one velocity sensor in the velocity encoder 510. The velocity encoder 510, more specifically the velocity sensor will be bypassed by the position sensor in the operative position encoder 520 and the position encoder 520 will be connected to the velocity decoder 515 using the selecting unit 530. A scaling may be done before bypassing the faulty velocity sensor. Similar swapping technique is applicable if the position encoder fails as well. The only change will be in the scaling factor that is involved in the switching process.

Some of the advantages of the invention include reducing or eliminating the uncontrolled motion caused due to failure or malfunction of an encoder in a motion control loop. Especially it eliminates the uncontrolled motion that can happen due to the failure of a position or velocity encoder in a feedback loop. The invention allows to control the erroneous motion which can occur in different axis. In medical imaging applications, this reduces the jerk of the patient experienced on a positioner while an uncontrolled motion occurs in the motion control system. The invention reduces the distance that need to be traveled before controlling the erroneous motion. The checking and controlling can be facilitated through an FPGA and hence can be achieved quickly. Thus the mechanism will reduce the stop distance well within the safety limits. As a result of reducing the uncontrolled motion, it eliminates the risk of collision of patient with gantry, X-ray detector or any other equipment in the vicinity. In another aspect the invention facilitate degraded mode of operation for at least one motion control cycle so that it will facilitate to complete the on going procedure and help to unload the patient safely in case of a medical imagining application. The motion control mechanism is a cost effective solution since it can be achieved through firmware. The encoder swapping occurs from the next motion control cycle onward and hence the user will not feel any jerk or shake because of the swapping. As the mechanism is achieved using digital techniques the controlling is very quick and the swapping occurs within I ms.

Thus various embodiments of the invention describe erroneous motion control system and method. Also in an embodiment the invention disclose effective way of detecting an encoder failure and swapping the faulty encoder with an operative encoder in the next motion control cycle.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

We claim:

1. A method of reducing or eliminating uncontrolled motion in a motion control system comprising:
defining at least one closed motion control loop, the motion control loop being configured to include a plurality of feedback control loops;
detecting a faulty feedback control loop from among the plurality of feedback control loops based on a faulty feedback signal; and
swapping of the faulty feedback signal in the faulty feedback control loop to an operative feedback signal while the motion control loop is active.

2. A method as in claim 1, wherein the step of defining a closed motion control loop comprises: defining a plurality of feedback control loops through an encoder and a controller.

3. A method as in claim 1, wherein the closed motion control loop includes a position feedback control loop and a velocity feedback control loop.

4. A method as in claim 3, wherein the position and velocity feedback control loops use a position feedback signal and a velocity feedback signal, respectively.

5. A method as in claim 1, wherein the step of detecting a faulty feedback control loop comprises: identifying a faulty feedback signal by continuously checking for non-availability of a signal from a feedback sensor.

6. A method as in claim 1, wherein the step of swapping comprises: scaling the output of an operative feedback sensor in accordance with the nature of a faulty feedback sensor; and passing the scaled output to the controller.

7. A method as in claim 6, wherein the step of passing the scaled output to the controller further comprises: completing the faulty feedback control loop through the operative feedback signal and the controller.

8. A method as in claim 1, further comprising: completing operative feedback control loops through the operative encoder and the controller.

9. A method as in claim 1, further comprising: completing at least one cycle of the motion control loop even after detecting the faulty feedback control loop.

10. A motion control mechanism comprising:
a faulty encoder detector; and
a feedback control mechanism for swapping a faulty encoder detected by the faulty encoder detector with an operative encoder in an active closed motion control loop.

11. A motion control mechanism as in claim 10, wherein the motion control loop includes a plurality of feedback control loops, the feedback control loops being defined through an encoder and a controller.

12. A motion control mechanism as in claim 10, wherein the faulty encoder detector is configured to generate a faulty feedback signal, during each cycle of the motion control loop, in response to the non-availability of a signal a feedback sensor from each encoder.

13. A motion control mechanism as in claim 10, wherein the feedback control mechanism is configured to scale an output of an operative encoder based on nature of a faulty encoder.

14. A motion control mechanism as in claim 13, wherein the feedback control mechanism is further configured to swap the faulty feedback sensor to an operative feedback sensor in responsive to the faulty feedback signal and the scaled output.

15. A motion control mechanism as in claim 14, wherein the feedback control mechanism is further configured to complete the motion control loop irrespective of the faulty encoder detector output.

16. A motion control system comprising:
a motion control loop defined by a plurality of feedback control loops;
a motion control mechanism operatively coupled to the motion control loop; and
a motor drive coupled to motion control mechanism;
wherein the motion control mechanism is configured to eliminate uncontrolled motion causing due to failure of the feedback control loop in the motion control loop.

17. A system as in claim 16, wherein the feedback control loop comprises a plurality of encoders along with a controller connected in feedback, the encoder being provided with a feedback sensor.

18. A system as in claim 17, wherein the feedback control loop includes a position control feedback loop and a velocity control feedback loop.

19. A system as in claim 16, wherein the motion control mechanism comprises: a faulty encoder detector to detect the failure of an encoder and a feedback control mechanism operably connected to the faulty encoder detector for swapping t the faulty encoder through an operative encoder.

20. A system as in claim 19, wherein the feedback control mechanism comprises a selecting unit, the selecting unit being configured to select an operative encoder upon detection of a faulty encoder.

21. A system as in claim 20, wherein the feedback control mechanism further comprises a scaling unit for scaling the output of the operative encoder based on the nature of the faulty encoder.

22. A system as in claim 21, wherein the feedback control mechanism is further configured to direct the scaled output of the selected operative encoder to the controller.

23. A system as in claim 22, wherein the feedback control mechanism is further configured to complete the motion control loop irrespective of the faulty encoder detector output.
